(19) United States
(12) Patent Application Publication
(10) Pub. No.: US 2024/0023471 A1
(43) Pub. Date: Jan. 25, 2024

(54) INFORMATION PROCESSING APPARATUS, INFORMATION PROCESSING SYSTEM, INFORMATION PROCESSING METHOD, AND WORK VEHICLE

(71) Applicant: TOYOTA JIDOSHA KABUSHIKI KAISHA, Toyota-shi (JP)

(72) Inventors: Yuki KUWAYAMA, Yokohama-shi (JP); Takeshi FUJIKI, Shinagawa-ku (JP); Rie MURAI, Chiba-shi (JP); Kohei MIWA, Suntoh-gun (JP); Akira MIYAMOTO, Nisshin-shi (JP); Tsuyoshi OKADA, Nagoya-shi (JP); Yu ITO, Nagoya-shi (JP)

(73) Assignee: TOYOTA JIDOSHA KABUSHIKI KAISHA, Toyota-shi (JP)

(21) Appl. No.: 18/355,621

(22) Filed: Jul. 20, 2023

(30) Foreign Application Priority Data
Jul. 20, 2022 (JP) 2022-115892

(51) Int. Cl. A01B 69/00; B64U 10/13; G05D 1/02

(52) U.S. Cl. CPC A01B 69/004; B64U 10/13; G05D 1/0214; G05D 1/0297; B64U 2101/30

(57) ABSTRACT

An information processing apparatus includes an interface configured to acquire route state information representing a state of a point through which at least one travel route of at least one work vehicle passes, and a controller configured to determine a travel route of the work vehicle based on the route state information and output the determined travel route to the work vehicle.

### CROSS-REFERENCE TO RELATED APPLICATION

This application claims priority to Japanese Patent Application No. 2022-115892, filed on Jul. 20, 2022, the entire contents of which are incorporated herein by reference.

### TECHNICAL FIELD

The present disclosure relates to an information processing apparatus, an information processing system, an information processing method, and a work vehicle.

### BACKGROUND

Agricultural vehicles with an automatic steering function are known. For example, see Patent Literature (PTL) 1.

### CITATION LIST

### Patent Literature

PTL 1: JP 2021-153421 A

### SUMMARY

If the state of a travel route is poor, a work vehicle may not be able to travel safely.

It would be helpful to improve the travel safety of work vehicles.

An information processing apparatus according to an embodiment of the present disclosure includes:
an interface configured to acquire route state information representing a state of a point through which at least one travel route of at least one work vehicle passes; and
a controller configured to determine a travel route of the work vehicle based on the route state information and output the determined travel route to the work vehicle.

An information processing system according to an embodiment of the present disclosure includes:
the information processing apparatus; and
a work vehicle.

An information processing method according to an embodiment of the present disclosure includes:
acquiring route state information representing a state of a point through which at least one travel route of at least one work vehicle passes; and
determining a travel route of the work vehicle based on the route state information and outputting the determined travel route to the work vehicle.

A work vehicle according to an embodiment of the present disclosure is a work vehicle for traveling along a travel route acquired from an information processing apparatus, the work vehicle including:
an information acquisition interface configured to detect a state of at least one point passed through during travel; and
an interface configured to output a result of detecting the state as route state information.

According to an embodiment of the present disclosure, the travel safety of work vehicles can be improved.

### BRIEF DESCRIPTION OF THE DRAWINGS

In the accompanying drawings:

FIG. 1 is a schematic diagram illustrating an example configuration of an information processing system according to an embodiment;

FIG. 2 is a block diagram illustrating an example configuration of an information processing system according to an embodiment; and

FIG. 3 is a flowchart illustrating an example procedure for an information processing method to be executed by an information processing apparatus according to an embodiment.

### DETAILED DESCRIPTION

Hereinafter, an embodiment of the present disclosure will be described.

### Configuration of Information Processing System 1

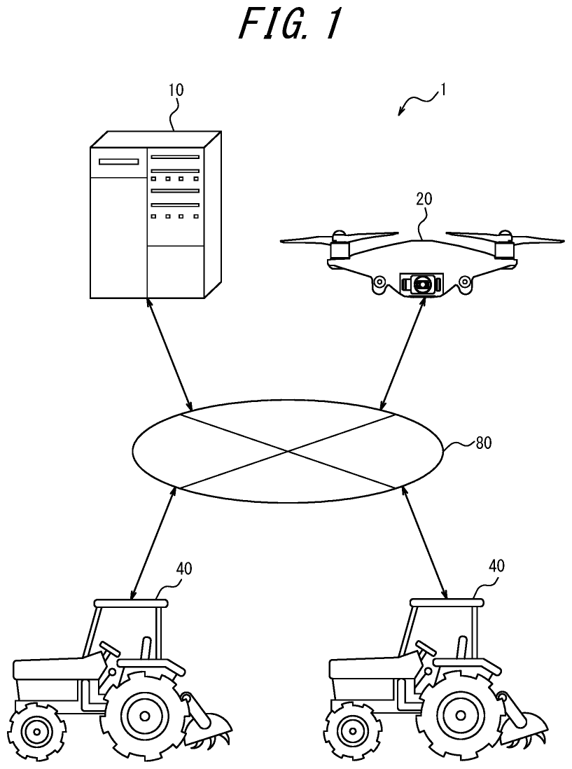

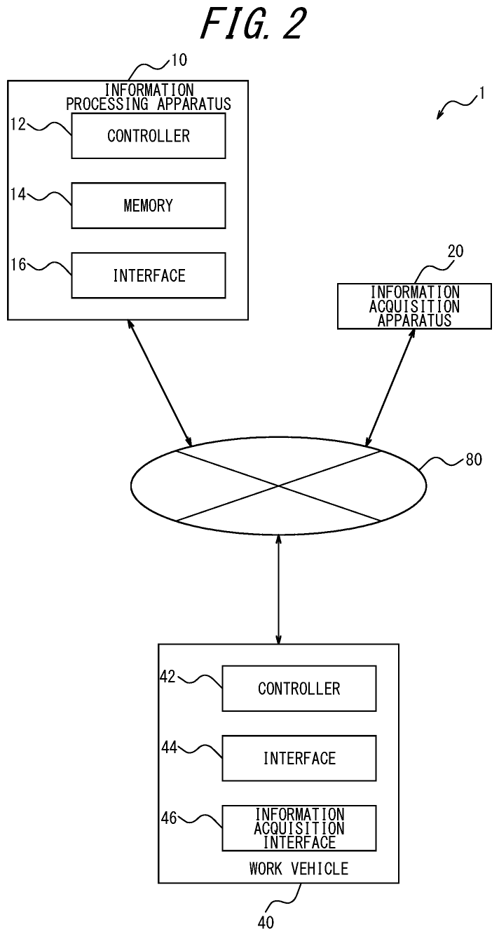

As illustrated in FIGS. 1 and 2, an information processing system 1 according to an embodiment of the present disclosure includes an information processing apparatus 10 and work vehicles 40. The information processing system 1 further includes a non-essential information acquisition apparatus 20. The information processing apparatus 10, the work vehicles 40, and the information acquisition apparatus 20 are communicably connected to a network 80 including, for example, the Internet, a mobile communication network, or the like.

The information processing system 1 determines the travel route of the work vehicle 40. Configurations of the information processing system 1 are described in detail below. In FIGS. 1 and 2, for ease of explanation, the number of information processing apparatuses 10 and information acquisition apparatuses 20 included in the information processing system 1 is one each, but the number may be two or more. The number of work vehicles 40 is two in FIG. 1 and one in FIG. 2, but these examples are not limiting, and the number may be three or more. The number of information processing apparatuses 10, information acquisition apparatuses 20, and work vehicles 40 included in the information processing system 1 may be set freely.

### Information Processing Apparatus 10

The information processing apparatus 10 may, for example, be configured as a computer such as a server apparatus. For example, the information processing apparatus 10 may be configured as a server that belongs to a cloud computing system or other computing systems. The information processing apparatus 10 is not limited to these examples and may be configured to include any general purpose electronic device, such as a personal computer (PC), or may be configured to include any other electronic device that is dedicated to the information processing system 1. The information processing apparatus 10 can communicate with the information acquisition apparatus 20 and the work vehicle 40 via the network 80. The information processing apparatus 10 may be mounted on a work vehicle 40.

In the present embodiment, the information processing apparatus 10 acquires information about the state of points through which the work vehicle 40 might travel. Information about the state of points through which the work vehicle 40 might travel is also referred to as route state information. Based on the route state information of a certain point, the information processing apparatus 10 determines whether the work vehicle 40 can travel through that point. As the travel route of the work vehicle 40, the information processing apparatus 10 may determine a route that passes through the point determined to be a point through which the work vehicle 40 can travel.

In other words, the information processing apparatus 10 assumes at least one travel route for the work vehicle 40 and acquires information about the state of at least one point through which each assumed travel route passes. Information about the state of the points through which the travel route passes is included in the route state information. The information processing apparatus 10 determines the travel route of the work vehicle 40 based on the route state information.

As illustrated in FIG. 2, the information processing apparatus 10 includes a controller 12, a memory 14, and an interface 16.

The controller 12 includes at least one processor, at least one dedicated circuit, or a combination thereof. The processor may include a general purpose processor, such as a central processing unit (CPU) or a graphics processing unit (GPU), or a dedicated processor specialized for particular processing. The dedicated circuit may include, for example, a field-programmable gate array (FPGA) or an application specific integrated circuit (ASIC). The controller 12 executes processes related to the operations of the information processing apparatus 10 while controlling the components of the information processing apparatus 10.

The memory 14 includes at least one semiconductor memory, at least one magnetic memory, at least one optical memory, or a combination of at least two of these. The semiconductor memory may, for example, include random access memory (RAM) or read only memory (ROM). The RAM may, for example, include static random access memory (SRAM) or dynamic random access memory (DRAM). The ROM may, for example, include electrically erasable programmable read only memory (EEPROM). The memory 14 functions as, for example, a main memory, an auxiliary memory, or a cache memory. The memory 14 stores programs and data to be used for the operations of the information processing apparatus 10 and data obtained by the operations of the information processing apparatus 10. The information stored in the memory 14 may be updated with, for example, information acquired from the network 80 via the interface 16.

The interface 16 includes at least one interface for external communication that connects to the network 80. The interface for communication may be an interface for either wired or wireless communication. In the case of wired communication, the interface for communication may, for example, include a Local Area Network (LAN) interface or a Universal Serial Bus (USB). In the case of wired communication, the interface for communication may, for example, include an interface compliant with a mobile communication standard such as a Long Term Evolution (LTE), 4th generation (4G), or 5th generation (5G), or an interface compliant with short-range wireless communication such as Bluetooth® (Bluetooth is a registered trademark in Japan, other countries, or both). The interface 16 receives data used in the operation of the information processing apparatus 10 from the information acquisition apparatus 20 or the work vehicle 40 and outputs data obtained by the operation of the information processing apparatus 10 to external apparatuses such as the work vehicle 40.

The interface 16 may further include an input device. The interface 16 may receive input of information with the input device. The input device may be configured with, for example, a touch panel, a touch sensor, or a pointing device such as a mouse. The input device may be configured with a physical key. The input device may be configured with an audio input device, such as a microphone. The input device is not limited to the above examples and may include various other devices.

The interface 16 may further include an output device. The interface 16 may output information with the output device. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices.

The functions of the information processing apparatus 10 are implemented by execution of a program, according to the information processing method of the present embodiment, by a processor corresponding to the controller 12. That is, the functions of the information processing apparatus 10 are realized by software. The information processing program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

The program in the present embodiment can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

### Information Acquisition Apparatus 20

The information acquisition apparatus 20 may be configured to include various cameras that capture images. The information acquisition apparatus 20 may acquire, as the route state information, images of at least one point through which the travel route of the work vehicle 40 passes. The information acquisition apparatus 20 may acquire, as the route state information, images of the surroundings of at least one point through which the travel route of the work vehicle 40 passes. The information acquisition apparatus 20 may acquire images within a predetermined range from at least one point through which the travel route of the work vehicle 40 passes.

The information acquisition apparatus 20 may be configured to include a distance measuring sensor that measures the distance to at least one point through which the travel route of the work vehicle 40 passes, or to objects existing within a predetermined range from that point. The information acquisition apparatus 20 may acquire, as the route state information, distance information or a distance map to at least one point through which the travel route of the work vehicle 40 passes, or to objects existing within a predetermined range from that point. The information acquisition apparatus 20 may be configured to acquire not only this information but also various other types of information as the route state information.

The information acquisition apparatus 20 may be configured as a mobile object on which a camera or sensor is mounted. The mobile object may be configured as a vehicle other than the work vehicle 40. The mobile object may be configured as a drone or other aircraft. The mobile object may be configured as a robot. The mobile object is not limited to these examples and may be configured in a variety of ways.

### Work Vehicle 40

The work vehicles 40 may include agricultural vehicles for performing agricultural work. The agricultural vehicles may include, for example, tractors. In greater detail, the agricultural vehicles may include vehicles that sow seeds or plant seedlings. The agricultural vehicles may include vehicles that cut and harvest crops or vehicles that dig up and harvest crops. The work vehicles 40 are not limited to agricultural vehicles and may include vehicles that perform a variety of other tasks. The work vehicles 40 may include vehicles powered by gasoline, light or heavy oil, or the like. The work vehicles 40 may include an electric vehicle such as a Battery Electric Vehicle (BEV), a Hybrid Electric Vehicle (HEV), a Plug-in Hybrid Electric Vehicle (PHEV), or a Fuel Cell Electric Vehicle (FCEV). The work vehicles 40 are not limited to these examples and may include vehicles driven by various other methods. The work vehicles 40 may be a manned vehicle or any autonomous vehicle that travels unmanned.

The work vehicles 40 perform agricultural work in agricultural areas or travel on agricultural roads. Agricultural roads may include public or private roads. The work vehicles 40 are also referred to as agricultural vehicles in the case of performing agricultural work.

Each work vehicle 40 may include a drive unit. The drive unit includes the drive mechanisms related to the movement or travel of the work vehicle 40. The drive unit includes the drive mechanisms related to the operations for the work performed by the work vehicle 40. The drive unit may, for example, include a rotating mechanism, sliding mechanism, or the like driven by a motor, engine, or the like.

As illustrated in FIG. 2, each work vehicle 40 includes a controller 42. The controller 42 includes at least one processor, at least one dedicated circuit, or a combination thereof. The processor may include a general purpose processor, such as a CPU or a GPU, or a dedicated processor that is dedicated to specific processing. Examples of dedicated circuits may include an FPGA and an ASIC. The controller 42 executes processes related to the operations of the work vehicle 40 while controlling the components of the work vehicle 40.

The controller 42 may include a memory. The memory includes one or more memories. The memories are semiconductor memories, magnetic memories, optical memories, or the like, for example, but are not limited to these. The memories included in the memory may each function as, for example, a main memory, an auxiliary memory, or a cache memory. The memory stores any information used for operations of the work vehicle 40. For example, the memory may store a system program, an application program, embedded software, or the like. The information stored in the memory may be updated with, for example, information acquired from the network 80.

Each work vehicle 40 further includes an interface 44. The interface 44 may be configured to include a communication interface. The communication interface includes at least one interface for external communication that connects to the network 80. The interface for communication may, for example, include an interface compliant with a mobile communication standard such as LTE, 4G, or 5G, or an interface compliant with a short-range wireless communication standard such as Bluetooth®, but these examples are not limiting. The communication interface receives data to be used for the operations of the work vehicle 40 and transmits data obtained by the operations of the work vehicle 40 to an external apparatus, such as the information processing apparatus 10.

The work vehicle 40 further includes an information acquisition interface 46. The information acquisition interface 46 may be configured to include various cameras that capture images. The information acquisition interface 46 may acquire, as the route state information, images along the travel route or of the surroundings of the travel route of the work vehicle 40. The information acquisition interface 46 may include a distance measuring sensor that measures the distance to objects on or around the travel route of the work vehicle 40. The information acquisition interface 46 may acquire, as the route state information, distance information or a distance map to objects existing along the travel route of the work vehicle 40 or around the travel route. The information acquisition interface 46 may be configured to acquire not only this information but also various other types of information as the route state information.

The information acquisition interface 46 may include a positional information acquisition device. The positional information acquisition device may include a receiver corresponding to the Global Positioning System (GPS), for example, but is not limited to this, and may include a receiver corresponding to any satellite positioning system. The positional information acquisition device may continuously acquire, or may periodically or non-periodically acquire, the positional information for the work vehicle 40.

The information acquisition interface 46 may be configured to acquire travel data of the work vehicle 40. The travel data may include information about the actual movement of the drive unit and the like as the work vehicle 40 travels. The travel data may include the acceleration of various parts of the work vehicle 40 or the results of detecting forces acting on various parts of the work vehicle 40 as the work vehicle 40 travels. The travel data is not limited to these examples and may include the results of detecting various parameters, including physical quantities related to the operation of the work vehicle 40, as the work vehicle 40 travels.

The information acquisition interface 46 outputs the acquired information to the information processing apparatus 10. The information acquisition interface 46 may output the acquired information to the information processing apparatus 10 via the interface 44.

The work vehicle 40 may have the information processing apparatus 10 mounted thereon. The controller 42 may be configured to function as the information processing apparatus 10.

### Operation Example of Information Processing System 1

In the information processing system 1 according to the present embodiment, the information processing apparatus 10 determines the travel route of the work vehicle 40 based on the route state information. The information processing apparatus 10 may determine a route such that the work vehicle 40 that is an agricultural vehicle passes through a non-public road, such as an agricultural area or an agricultural road, as the travel route. The information processing apparatus 10 may determine a route such that the work vehicle 40 that is a construction vehicle passes through a non-public road, such as a construction site or a construction access road, as the travel route. In other words, the information processing apparatus 10 may determine a route that at least partially passes through a non-public road as the travel route of the work vehicle 40. Below, an example of the operation of the information processing apparatus 10 when determining the travel route of a work vehicle 40 as an agricultural vehicle is described.

### Acquisition of Route State Information

The controller 12 of the information processing apparatus 10 acquires, using the interface 16, route state information representing the state of at least one point through which at least one travel route of the work vehicle 40 passes. The controller 12 may store the acquired route state information in the memory 14.

The controller 12 may set a candidate route for the travel route of the work vehicle 40 and acquire, using the interface 16, route state information representing the state of at least one point through which the candidate route passes. The controller 12 may register candidate routes for the work vehicle 40 in advance. The routes registered in advance are also referred to as registered routes. The controller 12 may acquire, using the interface 16, information representing the state of at least one point through which a registered route passes. The information representing the state of at least one point through which a registered route passes is also referred to as registered route information.

In the information processing system 1, the work vehicle 40 may acquire the route state information. Specifically, the work vehicle 40 may acquire, using the information acquisition interface 46, information representing the state of a point through which the work vehicle 40 has traveled and output the information to the information processing apparatus 10. The information acquisition interface 46 may, for example, acquire travel data for the work vehicle 40 at a point through which the work vehicle 40 has traveled as the route state information. The controller 12 may calculate the amount of slip of the work vehicle 40 caused by muddiness or the like at at least one point based on the travel data of the work vehicle 40. The controller 12 may calculate the magnitude of vibration of the work vehicle 40 caused by road surface unevenness or the like at at least one point based on the travel data of the work vehicle 40.

The information acquisition interface 46 may, for example, acquire images of a point through which the work vehicle 40 traveled, or images within a predetermined range from the point through which the work vehicle 40 traveled, as the route state information and output the images to the information processing apparatus 10. The information acquisition interface 46 may acquire images of an agricultural area or the like located around the point through which the work vehicle 40 traveled as the route state information and output the images to the information processing apparatus 10. The information acquisition interface 46 may, for example, acquire distance data to objects existing at the point through which the work vehicle 40 traveled, or objects existing within a predetermined range from that point, as the route state information and output the distance data to the information processing apparatus 10.

The controller 12 may acquire the route state information from a work vehicle 40 that actually traveled the candidate route. The controller 12 may acquire the route state information from a work vehicle 40 that traveled through a point through which the candidate route passes.

In the information processing system 1, the information acquisition apparatus 20 may acquire the route state information. The information acquisition apparatus 20 may acquire the route state information for at least one point through which the candidate route set by the controller 20 passes.

The information acquisition apparatus 20 may, for example, capture images of at least one point through which the candidate route passes, or images within a predetermined range from that point, and output the images to the information processing apparatus 10 as the route state information. The information acquisition apparatus 20 may, for example, acquire distance data to the point through which the work vehicle 40 traveled, or objects existing within a predetermined range from that point, as the route state information and output the distance data to the information processing apparatus 10.

The controller 12 may control the information acquisition apparatus 20 to move to at least one point of the set candidate route. The controller 12 may control the information acquisition apparatus 20 to acquire the route state information for the point to which the information acquisition apparatus 20 was moved and may acquire the route state information for that point from the information acquisition apparatus 20.

The controller 12 may analyze the route state information acquired from the information acquisition apparatus 20 or the information acquisition interface 46 of the work vehicle 40 and detect anomalies in real time. In a case in which an anomaly is detected, the controller 12 may request the information acquisition apparatus 20 or the information acquisition interface 46 to capture more detailed images or acquire more detailed information, or to capture a video.

The information acquisition apparatus 20 or the information acquisition interface 46 may analyze the captured images or detected information in real time and output information to the information processing apparatus 10 only in a case in which an abnormality is detected.

In this way, the controller 12 can acquire detailed information only when an anomaly is detected. As a result, the load on the information processing apparatus 10 can be reduced.

### Determination of Travel Route Based on Route State Information

The controller 12 determines the travel route of the work vehicle 40 based on the route state information. Specifically, the controller 12 determines, based on the route state information of at least one point through which a candidate route for the travel route passes, whether the work vehicle 40 can travel through that point. The controller 12 determines the travel route of the work vehicle 40 so as to pass through the point through which the work vehicle 40 can travel. In other words, the controller 12 determines the travel route of the work vehicle 40 so as not to pass through a point through which the work vehicle 40 cannot travel.

The point for which it is determined whether the work vehicle 40 can travel is also referred to as a determination target point. The controller 12 may determine that the work vehicle 40 can travel through the determination target point in a case in which the state of the determination target point satisfies a predetermined condition. The controller 12 may set a predetermined condition such that unevenness on the road surface at the determination target point is not equal to or greater than a predetermined value. The controller 12 may set a predetermined condition such that no object larger than a predetermined size exists at the determination target point or within a predetermined range from the determination target point. The controller 12 may set a predetermined condition such that the road surface at the determination target point or within a predetermined range from the determination target point can withstand the weight of the work vehicle 40. The controller 12 may set a predetermined condition such that the road surface at the determination target point or within a predetermined range from the determination target point can withstand the vibration, shock, or the like when the work vehicle 40 travels. The controller 12 may set a predetermined condition such that the water level of a river, pond, or the like within a predetermined range from the determination target point is below a predetermined water level (for example, a warning water level).

The controller 12 may acquire information representing a standard state of the determination target point. The information representing the standard state is also referred to as standard state information. The standard state may, for example, be the state in which it is determined that the work vehicle 40 can travel through the determination target point. The standard state may be the normal state of the determination target point. The normal state may, for example, be the state that is maintained at a determination target point for a predetermined percentage or greater of days within a predetermined period of time.

The controller 12 may determine whether the work vehicle 40 can travel through the determination target point based on a comparison between the standard state information representing the standard state of the determination target point and route state information representing the detected state (current state) of the determination target point. The controller 12 may determine that the state of the determination target point is the standard state in a case in which the difference between the standard state information and the route state information satisfies a predetermined condition.

Specifically, the controller 12 may generate the difference between the standard state information and the route state information for various parameters. The controller 12 may, for example, calculate the difference in the magnitude of the unevenness of the road surface at the determination target point as the difference between the standard state information and the route state information. The controller 12 may, for example, calculate the difference in the number of objects existing at the determination target point or within a predetermined range from the determination target point as the difference between the standard state information and the route state information. The controller 12 may, for example, calculate the difference in the size of objects existing at the determination target point or within a predetermined range from the determination target point as the difference between the standard state information and the route state information. The controller 12 may, for example, calculate the difference in the load that the road surface can withstand at the determination target point as the difference between the standard state information and the route state information. The controller 12 may, for example, calculate the difference in the water level of a river, pond, or the like within a predetermined range from the determination target point as the difference between the standard state information and the route state information. The controller 12 may, for example, calculate the difference in the slip amount or the magnitude of vibration occurring due to the work vehicle 40 traveling through the determination target point as the difference between the standard state information and the route state information.

The controller 12 may set a determination condition on the difference calculated for each parameter. The determination condition may include that the absolute value of the difference is less than a predetermined value. The controller 12 may determine that the state of the determination target point is the standard state in a case in which the difference for all parameters satisfies the determination condition. The controller 12 may determine that the work vehicle 40 can travel through the determination target point in a case in which the difference for all parameters satisfies the determination condition. Conversely, the controller 12 may determine that the state of the determination target point is not the standard state, or that the work vehicle 40 cannot travel through the determination target point, in a case in which the difference for at least one parameter does not satisfy the determination condition. The controller 12 may determine that the state of the determination target point is the standard state, or that the work vehicle 40 can travel through the determination target point, in a case in which the difference satisfies the determination condition for a predetermined percentage or more of the parameters among a plurality of parameters.

The controller 12 may set the determination condition appropriately to tighten or loosen the constraints for determining the travel route of the work vehicle 40. The controller 12 may appropriately set the percentage (predetermined percentage) of the parameters that should satisfy the determination condition among the plurality of parameters.

The controller 12 determines the travel route of the work vehicle 40 so as not to pass through a point through which it was determined that the work vehicle 40 cannot travel. The controller 12 may determine the travel route of the work vehicle 40 so as to pass through a point through which it was determined that the work vehicle 40 can travel. In a case in which the controller 12 cannot generate a route connecting the points through which it is determined that the work vehicle 40 can travel, the controller 12 may repeat the determination with regard to route state information for other determination target points.

The controller 12 outputs the determined travel route to the work vehicle 40. The work vehicle 40 may be driven automatically by the controller 42 or driven by a human driver along the travel route acquired from the information processing apparatus 10. The work vehicle 40 may display the travel route, or output the travel route by voice guidance, using the interface 44 for the driver to recognize the acquired travel route.

### Validity Period of Route State Information

The state of the points through which the travel route passes can change over time. For example, rain can cause changes in the water level or loosening of the ground. Wind or the like can also lead to obstacles on the route. Furthermore, the topography could be deformed by earthquakes or the like. The state of points along the route may also be artificially changed.

To account for changes in the state of the points through which the travel route passes, the controller 12 may set a validity period for the route state information. When acquiring route state information for a certain point from the work vehicle 40 or the information acquisition apparatus 20, the controller 12 may also acquire the date and time when the state of that point was detected. The controller 12 may store the route state information and the date and time of detection of that information in association in the memory 14. The controller 12 may set the validity period of the route state information based on the date and time of detection of the route state information. The controller 12 may appropriately set the length of the validity period based on a weather forecast or the like. In a case in which, for example, rain or wind is expected to intensify, the controller 12 may estimate that the state of each point through which the travel route passes is likely to change and may set the validity period to a shorter period.

The controller 12 takes into account the validity period set in the route state information that represents the state of the determination target point when determining the state of the determination target point. In a case in which the validity period of the route state information for a certain determination target point has been exceeded, the controller 12 does not determine the state of that determination target point or whether the work vehicle 40 can travel. The controller 12 determines the state of a determination target point and whether the work vehicle 40 can travel through the determination target point based only on route state information within the validity period.

The controller 12 may update information, among the route state information, for which the validity period has been exceeded. A point corresponding to route state information for which the validity period has been exceeded is also referred to as an update target point. The controller 12 may control the work vehicle 40 to travel through the update target point and acquire route state information representing the latest state of the update target point. The controller 12 may control the information acquisition apparatus 20 to move to the update target point and acquire route state information representing the latest state of the update target point. The controller 12 may control an aircraft as the information acquisition apparatus 20 to move to the update target point and acquire route state information representing the latest state of the update target point. The controller 12 may control a vehicle smaller than the work vehicle 40 as the information acquisition apparatus 20 to travel to the update target point and acquire route state information representing the latest state of the update target point. Use of an aircraft or a small vehicle can avoid entry of the work vehicle 40 at a point through which the work vehicle 40 cannot travel. As a result, the travel safety of the work vehicle 40 can be improved.

In cases such as when a typhoon passes through, rainfall or wind speed exceeds a predetermined value, or an earthquake occurs, the controller 12 may consider each point as an update target point and acquire route state information representing the latest state of each update target point, regardless of the validity period of the route state information. In this way, the travel safety of the work vehicle 40 can be improved.

### Example Procedure for Information Processing Method

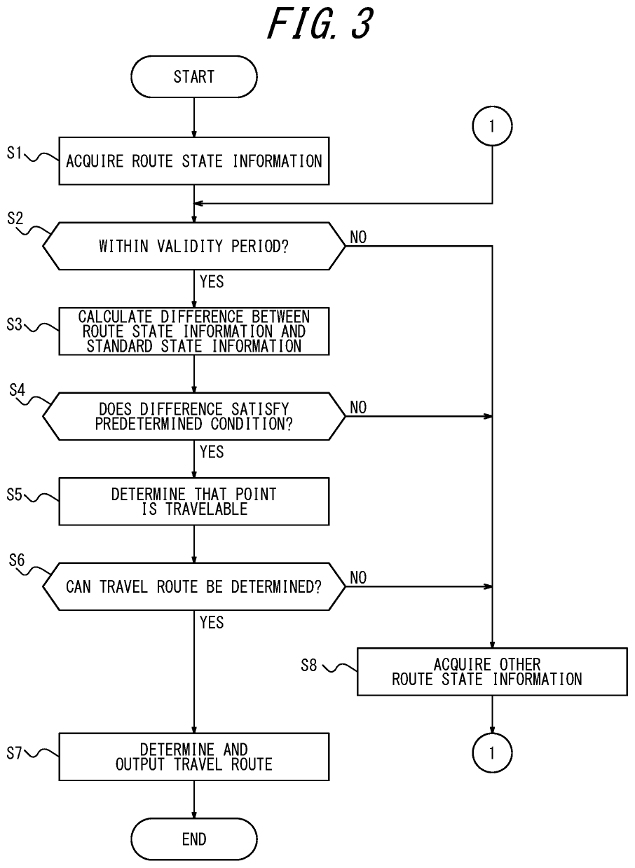

The controller 12 of the information processing apparatus 10 according to the present embodiment may perform an information processing method including the procedures of the flowchart in FIG. 3, for example, to determine the travel route of the work vehicle 40. The information processing method may be implemented as an information processing program to be executed by the controller 12. The information processing program may be stored on a non-transitory computer readable medium.

The controller 12 acquires route state information for the determination target point (step S1). The controller 12 determines whether the route state information is within the validity period (step S2). In a case in which the route state information has exceeded the validity period, i.e., in a case in which the route state information is not within the validity period (step S2: NO), the controller 12 proceeds to step S8.

In a case in which the route state information is within the validity period (step S2: YES), the controller 12 calculates the difference between the route state information and the standard state information (step S3). The controller 12 determines whether the difference satisfies a predetermined condition (step S4). In a case in which the difference does not satisfy the predetermined condition (step S4: NO), the controller 12 proceeds to step S8.

In a case in which the difference satisfies the predetermined condition (step S4: YES), the controller 12 determines that the determination target point is a point through which the work vehicle 40 can travel (step S5). The controller 12 determines whether the travel route of the work vehicle 40 can be determined so as to pass through the point through which it was determined that the work vehicle 40 can travel (step S6). In a case in which the travel route of the work vehicle 40 cannot be determined (step S6: NO), the controller 12 proceeds to step S8.

In a case in which the travel route of the work vehicle 40 can be determined (step S6: YES), the controller 12 determines the travel route of the work vehicle 40 and outputs the travel route to the work vehicle 40 (step S7). After performing the procedure of step S7, the controller 12 can end the execution of the procedures in the flowchart of FIG. 3.

In a case in which it is determined that the route state information is not within the validity period in the determination procedure in step S2, that the difference does not satisfy the predetermined condition in the determination procedure in step S4, or that the travel route of the work vehicle 40 cannot be determined in the determination procedure in step S6, the controller 12 acquires the route state information for another determination target point (step S8). After execution of the procedure in step S8, the controller 12 returns to the procedure in step S2 and repeats the determination of the state of the determination target point until the travel route of the work vehicle 40 can be determined.

### SUMMARY

As described above, in the information processing system 1 and the information processing apparatus 10 according to the present embodiment, the travel route of the work vehicle 40 is determined based on the route state information. In this way, the travel safety of the work vehicle 40 can be improved.

Based on the route state information acquired by a work vehicle 40 actually traveling, the controller 12 of the information processing apparatus 10 can determine the travel route of that work vehicle 40 or of another work vehicle 40. The work vehicle 40 that acquires the route state information is also referred to as the first work vehicle. The other work vehicle 40, which differs from the first work vehicle, is also referred to as the second work vehicle. In other words, among the work vehicles 40, the controller 12 may determine the travel route of the second work vehicle based on information representing the state of a point through which the first work vehicle has actually travelled. In this way, the work vehicles 40 can use each other's route state information. Hazardous areas on private property, such as an agricultural area, or on private roads, such as agricultural roads, are less likely to be detected than hazardous areas on public roads. Determination of the travel route using the route state information detected by the work vehicles 40 enables detection of hazardous areas by the work vehicles 40 themselves. As a result, the travel safety of the work vehicle 40 can be improved.

The information processing apparatus 10 may be mounted on a work vehicle 40. In this case, the work vehicle 40 can determine the travel route using the information processing apparatus 10 mounted on the work vehicle 40 itself. In this way, the travel route is determined based on the latest state acquired by the work vehicle 40 itself. As a result, the travel safety of the work vehicle 40 can be improved.

As described above, the route state information includes information that represents the state of a predetermined range from the determination target point. The predetermined range for which route state information is to be acquired may be set as appropriate based on the specifications of the work vehicle 40. The predetermined range may, for example, be set based on the size, weight, or the like of the work vehicle 40. For example, the predetermined range may be set wider as the work vehicle 40 is larger.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 10 in the above embodiment are distributed to multiple computers capable of communicating with each other can be implemented. For example, an embodiment in which some of the functions of the information processing apparatus 10 are provided in the controller 42, the information acquisition apparatus 20, or the like can also be implemented.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.
[Appendix 1] An information processing apparatus comprising:
   an interface configured to acquire route state information representing a state of a point through which at least one travel route of at least one work vehicle passes; and
   a controller configured to determine a travel route of the work vehicle based on the route state information and output the determined travel route to the work vehicle.
[Appendix 2] The information processing apparatus according to appendix 1, wherein the controller is configured to determine a route that at least partially passes through a non-public road as the travel route of the work vehicle.
[Appendix 3] The information processing apparatus according to appendix 1 or 2, wherein the interface is configured to acquire, as the route state information, information representing a state of a point through which the work vehicle has actually traveled from the work vehicle.
[Appendix 4] The information processing apparatus according to appendix 3, wherein the interface is configured to acquire, as the route state information, travel data for the work vehicle at a point through which the work vehicle has actually traveled.
[Appendix 5] The information processing apparatus according to any one of appendices 1 to 4, wherein the interface is configured to acquire the route state information from an information acquisition apparatus.
[Appendix 6] The information processing apparatus according to any one of appendices 1 to 5, wherein the interface is configured to acquire, as the route state information, images within a predetermined range including a point through which the travel route passes.
[Appendix 7] The information processing apparatus according to any one of appendices 1 to 6, wherein the interface is configured to acquire, as the route state information, registered route information representing a state of a point passed through by a registered route that is registered in advance as a candidate for the travel route of the work vehicle.
[Appendix 8] The information processing apparatus according to any one of appendices 1 to 7, wherein the controller is configured to determine the travel route of the work vehicle based on information about a difference between the route state information and standard state information representing a standard state of a point corresponding to the route state information.
[Appendix 9] The information processing apparatus according to any one of appendices 1 to 8, further comprising a memory configured to store the route state information, wherein
   the controller is configured to store a validity period in the memory in association with the route state information.
[Appendix 10] The information processing apparatus according to appendix 9, wherein the controller is configured to determine the travel route of the work vehicle based on information within the validity period among the route state information stored in the memory.
[Appendix 11] The information processing apparatus according to appendix 9 or 10, wherein the controller is configured to control the work vehicle to travel through an update target point corresponding to information that has exceeded the validity period among the route state information and acquire information representing a state of the update target point.
[Appendix 12] The information processing apparatus according to any one of appendices 9 to 11, wherein the controller is configured to acquire, from an information acquisition apparatus, information representing a state of an update target point corresponding to information that has exceeded the validity period among the route state information.
[Appendix 13] The information processing apparatus according to appendix 12, wherein the controller is configured to control an aircraft, or a vehicle smaller than the work vehicle, as the information acquisition apparatus to move to the update target point and acquire information representing the state of the update target point.
[Appendix 14] The information processing apparatus according to any one of appendices 1 to 13, wherein the at least one work vehicle comprises a first work vehicle and a second work vehicle different from the first work vehicle, and the controller is configured to determine a travel route of the second work vehicle based on information representing a state of a point through which the first work vehicle has actually traveled.
[Appendix 15] The information processing apparatus according to any one of appendices 1 to 14, wherein the information processing apparatus is mounted on the work vehicle.
[Appendix 16] An information processing system comprising:
   the information processing apparatus according to any one of appendices 1 to 15; and
   the work vehicle.
[Appendix 17] An information processing method comprising:
   acquiring route state information representing a state of a point through which at least one travel route of a work vehicle passes; and
   determining a travel route of the work vehicle based on the route state information and outputting the determined travel route to the work vehicle.
[Appendix 18] The information processing method according to appendix 17, further comprising determining a route that at least partially passes through a non-public road as the travel route of the work vehicle.
[Appendix 19] The information processing method according to appendix 17 or 18, further comprising determining the travel route of the work vehicle based on information about a difference between the route state information and standard state information representing a standard state of a point corresponding to the route state information.
[Appendix 20] A work vehicle for traveling along a travel route acquired from an information processing apparatus, the work vehicle comprising:
   an information acquisition interface configured to detect a state of at least one point passed through during travel; and
   an interface configured to output a result of detecting the state as route state information.

1. An information processing apparatus comprising:
an interface configured to acquire route state information representing a state of a point through which at least one travel route of at least one work vehicle passes; and
a controller configured to determine a travel route of the work vehicle based on the route state information and output the determined travel route to the work vehicle.

2. The information processing apparatus according to claim 1, wherein the controller is configured to determine a route that at least partially passes through a non-public road as the travel route of the work vehicle.

3. The information processing apparatus according to claim 1, wherein the interface is configured to acquire, as the route state information, information representing a state of a point through which the work vehicle has actually traveled from the work vehicle.

4. The information processing apparatus according to claim 3, wherein the interface is configured to acquire, as the route state information, travel data for the work vehicle at a point through which the work vehicle has actually traveled.

5. The information processing apparatus according to claim 1, wherein the interface is configured to acquire the route state information from an information acquisition apparatus.

6. The information processing apparatus according to claim 1, wherein the interface is configured to acquire, as the route state information, images within a predetermined range including a point through which the travel route passes.

7. The information processing apparatus according to claim 1, wherein the interface is configured to acquire, as the route state information, registered route information representing a state of a point passed through by a registered route that is registered in advance as a candidate for the travel route of the work vehicle.

8. The information processing apparatus according to claim 1, wherein the controller is configured to determine the travel route of the work vehicle based on information about a difference between the route state information and standard state information representing a standard state of a point corresponding to the route state information.

9. The information processing apparatus according to claim 1, further comprising a memory configured to store the route state information, wherein
the controller is configured to store a validity period in the memory in association with the route state information.

10. The information processing apparatus according to claim 9, wherein the controller is configured to determine the travel route of the work vehicle based on information within the validity period among the route state information stored in the memory.

11. The information processing apparatus according to claim 9, wherein the controller is configured to control the work vehicle to travel through an update target point corresponding to information that has exceeded the validity period among the route state information and acquire information representing a state of the update target point.

12. The information processing apparatus according to claim 9, wherein the controller is configured to acquire, from an information acquisition apparatus, information representing a state of an update target point corresponding to information that has exceeded the validity period among the route state information.

13. The information processing apparatus according to claim 12, wherein the controller is configured to control an aircraft, or a vehicle smaller than the work vehicle, as the information acquisition apparatus to move to the update target point and acquire information representing the state of the update target point.

14. The information processing apparatus according to claim 1, wherein the at least one work vehicle comprises a first work vehicle and a second work vehicle different from the first work vehicle, and the controller is configured to determine a travel route of the second work vehicle based on information representing a state of a point through which the first work vehicle has actually traveled.

15. The information processing apparatus according to claim 1, wherein the information processing apparatus is mounted on the work vehicle.

16. An information processing system comprising:
the information processing apparatus of claim 1; and
the work vehicle.

17. An information processing method comprising:
acquiring route state information representing a state of a point through which at least one travel route of a work vehicle passes; and
determining a travel route of the work vehicle based on the route state information and outputting the determined travel route to the work vehicle.

18. The information processing method according to claim 17, further comprising determining a route that at least partially passes through a non-public road as the travel route of the work vehicle.

19. The information processing method according to claim 17, further comprising determining the travel route of the work vehicle based on information about a difference between the route state information and standard state information representing a standard state of a point corresponding to the route state information.

20. A work vehicle for traveling along a travel route acquired from an information processing apparatus, the work vehicle comprising:
an information acquisition interface configured to detect a state of at least one point passed through during travel; and
an interface configured to output a result of detecting the state as route state information.
